(19) United States
(12) Patent Application Publication
(10) Pub. No.: US 2008/0052772 A1
(43) Pub. Date: Feb. 28, 2008

(54) Preserving Privacy While Using Authorization Certificates

(75) Inventors: Claudine Viegas Conrado, Eindhoven (NL); Pim Theo Tuyls, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,668

(22) PCT Filed: Dec. 13, 2004
(86) PCT No.: PCT/IB04/52793

§ 371 Date: Jun. 21, 2006

(30) Foreign Application Priority Data
Dec. 24, 2003 (EP) 03104970.3

(51) Int. Cl. H04L 9/32

(52) U.S. Cl. 726/10; 380/277

(57) ABSTRACT

The invention proposes a method to provide privacy for users or a user from a group of users with respect to authorizations they are granted, where such authorizations are expressed using digital authorization certificates, and with respect to domain certificates in case of groups of users. The idea is to conceal the user identity in the certificates, while the certificate itself remains in the clear. In this way, certificates can be widely and openly available, e.g. in a public network, without a random observer being able to link a user to an authorization or to identify a user within a domain. Privacy is also provided towards the certificate verifier by means of zero-knowledge protocols, which are carried out between the user and the verifier in order for the verifier to check a user's entitlement to a certificate. Privacy is further provided towards the certificate issuer as well, by means of a mechanism that allows the anonymous (buying or) issuing of certificates from the issuer.

The invention relates to a method of preserving privacy for a user while enabling the user controlled access to data. The invention further relates to a user device for preserving privacy for a user while enabling the user controlled access to data. The invention further relates to a verifier device for preserving privacy for a user while enabling the user controlled access to data. The invention further relates to an issuing device for preserving privacy for a user while enabling the user controlled access to data. The invention further relates to a signal for preserving privacy for a user while enabling the user controlled access to data.

The invention further relates to a computer program product for preserving privacy for a user while enabling the user controlled access to data.

The SPKI/SDSI (Simple Public Key Infrastructure/Simple Distributed Security Infrastructure) certificate framework is described in Ellison, C., “SPKI/SDSI certificates”, http://world.std.com/˜cme/html/spki.html. Within this framework, authorization certificates can be defined by means of which an authorization or right is granted to the public key of a person by an authority which signs the certificate. In addition to the authorization and the subject, SPKI authorization certificates also include the public key of the issuing authority, and may also include a validity specification for the certificate and a delegation tag.

Authorization certificates may be carried by the user (e.g., in their user devices), or may be available anywhere in the network (to avoid the burden on the user of carrying all his certificates) to allow easy access to those certificates to a verifier. In this case, all information present in the certificate is in the clear in the network and available for anyone to see.

For authorization certificates, their issuing, their possible public wide availability as well as their use may raise privacy problems for users who do not want to disclose to other parties their association with a given authorization. In the case of authorizations as rights to access content, users may not want to be associated with certain content. Privacy problems exist for a number of reasons. First, a public key (or its hash) is a globally unique identifier of the user. Moreover, it is easy to bind a public key to its owner, since the key is public and it is used in any transaction to authenticate the user. Second, the availability discussed above implies that there is a direct and easily accessible link (the authorization certificate available everywhere in the network) between users and an authorization. Third, given a certain public key, i.e. a certain person, it is very easy for an observer to find all the authorization certificates of that person by simply doing a search in the network on that public key. Fourth and finally, even if certificates are carried and kept privately by users, the certificate issuer and the certificate verifier will always know that association between the user and the authorization, since they have (and need) access to the certificates.

A solution is required that ensures and preserves privacy for users with respect to their certificates, while allowing easy access any time and anywhere to those certificates by a verifier.

In patent application EP03100737.0 (attorney docket PHNL030293), a method is described aiming to preserve privacy for at least one user of obtained authorizations that can be used in an access and authorization system, while at the same time allowing the proper and secure check of the users entitlement to said authorization. It proposes to hide the link between user identities and content rights by using concealing data to conceal the user identity (the public key) in the user identifying information, while still allowing any device to check the certificates. This solution still suffers from privacy problems. When a user accesses content, his identity is revealed, and all the user's actions of accessing content can be linked to his identity. In the process of a user accessing content, however, the device always learns the public key of the user, revealing his identity. Even worse, it enables that all the user's actions of accessing content can be linked to his identity, so, with a co-operation of certificates verifiers, the user can be tracked. Also, there is no privacy towards the certificate issuer.

There is therefore a further need to provide privacy towards third parties such as the certificate verifier and also the certificate issuer.

It is an object of the present invention to provide a method for issuing and/or verifying a certificate for a user, preserving privacy for that user, which prevents the certificate issuer and certificate verifier from learning the user identity (public key) of that user, in a way that the user's entitlement to the certificate can still be verified.

This object is achieved by a method of preserving privacy for a user while enabling the user controlled access to data, the user being represented by a user device and identified by a user identity, the method using at least one certificate that associates data access rights with the user identity, wherein the certificate conceals the user identity, wherein the certificate comprises publicly available solution information P, a concealed secret S′ is publicly available, the method further comprises at least one of:
a certificate verification process between the user device and a verifier device,
a certificate issuing process between the user device and an issuing device, and
a certificate re-issuing process between the user device and the issuing device,
   wherein the certificate verification process comprises the steps of:
the user device obtaining the concealed secret S′ corresponding to the certificate,
the user device retrieving the secret S from the concealed secret S′,
the verifier device obtaining the solution information P from the certificate,
the user device proving to the verifier device that it knows the secret S without the verifier device learning the secret S or the user identity,
   wherein the certificate issuing process comprises the steps of:
generating a secret S and a solution information P,
concealing the secret S into a concealed secret S′,
the issuing device issuing a certificate comprising at least the solution information P,
   wherein the certificate re-issuing process comprises the steps of:
the user device obtaining the concealed secret S′ corresponding to the certificate,
the user device retrieving the secret S from the concealed secret S′,
the issuing device obtaining the solution information P from the certificate,
the user device proving to the issuing device that it knows the secret S without the issuing verifier device learning the secret S or the user identity,
generating a new secret S2 and new solution information P2,
concealing the secret S2 into a concealed secret S2′,
the issuing device issuing a new certificate comprising at least the new solution information P2.

The user identity and public key are not available in clear format in the certificate, and are also not needed for the verifier to verify the authorization. The authorization is verified by the user proving to the verifier device that the user knows the secret contained in the authorization.

Because the secret S itself is not revealed, the verifier can not impersonate himself as the user related to the authorization, and privacy is preserved.

An advantageous implementation of the method according to the invention is described in claim 2. The concealed secret S′ is now also conveniently stored in the certificate.

An advantageous implementation of the method according to the invention is described in claim 3. As only the user has access to the private key, only the user can retrieve the secret S.

A further advantageous implementation of the method according to the invention is described in claim 4.

An advantageous implementation of the method according to the invention is described in claim 5. By the use of random information, the secret S can be better concealed.

A further advantageous implementation of the method according to the invention is described in claim 6. By using a zero knowledge protocol between the verifier and the user, the knowledge of the secret S is proven but the secret itself is not revealed.

A further advantageous implementation of the method according to the invention is described in claim 7. By establishing a symmetric session key K the issuing process is protected.

A further advantageous implementation of the method according to the invention is described in claim 8. In order that nobody else knows the secret S, the secret is preferably generated by the user device itself in the issuing process.

The invention can be applied advantageously for an authorization certificate, as defined in claim 9, or can be applied advantageously for a domain certificate, as defined in claim 10.

In patent application EP02079390.7 (attorney docket PHNL021063), a method is proposed which describes an architecture for an authorized domain based on persons. Access to content is granted to any of the persons in the domain based on a few steps. Person A (who bought the content) may access content 1 on a device by means of authentication, e.g. with A's user device, and the usage right certificate, a certificate which links A to content rights 1. Persons B, C, and D (who belong to the same domain as A) may access content 1 on a device by means of authentication based on the usage right certificate which links A to content rights 1, and the domain certificate, a certificate which groups A, B, C and D together. When a person performs an action that requires him to show that he is a participant in a domain, his user identity (public key) is revealed as it is part of the domain certificate.

A domain certificate according to the invention contains one or more concealed secrets of which the secret can only be retrieved (and knowledge thereof proven) by the domain members. This enables the domain members to anonymously prove their membership in the domain.

An advantageous implementation of the method according to the invention is described in claim 11. As each domain member has access to the secret domain key, the domain members made retrieve the secret S from the domain certificate.

A further advantageous implementation of the method according to the invention is described in claim 12. The usage right certificate may comprise a concealed secret (such as D in the second embodiment described below) that links the usage right certificate to a domain in order to allow the (other) domain users (the co-users) to prove their entitlement to the usage right certificate.

A further advantageous implementation of the method according to the invention is described in claim 13. Different access levels can be from last by having a rule with right specifications, stating the different permissions a user is entitled to when proving either secret.

It is a further object of the present invention to provide a user device that can request a certificate or prove entitlement to a certificate according to the invention, preserving the privacy of its user identity. This object is achieved by a user device being arranged for issuing a certificate according to claim 1, comprising:
receiving means for receiving process information,
computing means, comprising processing, encryption/decryption and storing means, for engaging in at least one of the certificate verification process, the certificate issuing process, and certificate re-issuing process,
transmitting means for transmitting process information.

It is a further object of the present invention to provide a verifier device for verifying a user's entitlement to a certificate, while preserving the privacy of the user. This object is achieved by a verifier device being arranged for verifying a certificate according to claim 1, comprising:
receiving means for receiving process information,
computing means, comprising processing, encryption/decryption and storing means, for engaging in the certificate verification process,
transmitting means for transmitting process information.

It is a further object of the present invention to provide an issuing device for issuing a certificate according to the invention, preserving the privacy of the user. This object is achieved by an issuing device being arranged for issuing a certificate according to claim 1, comprising:
receiving means for receiving process information,
computing means, comprising processing, encryption/decryption and storing means, for engaging in at least one of the certificate issuing process and certificate re-issuing process,
transmitting means for transmitting process information.

It is a further object of the present invention to provide a signal for preserving privacy while enabling the user controlled access to data. This object is achieved by a signal carrying at least part of a certificate as used in the method according to claim 1.

It is a further object of the present invention to provide a computer program product for preserving privacy for a user while enabling the user controlled access to data. This object is achieved by a computer program product carrying computer executable instructions comprising a computer readable medium, having thereon computer program code means, to make a computer execute, when said computer program code means is loaded in the computer, implementing at least one protocol side of at least one of:
the certificate issuing protocol,
the certificate re-issuing protocol, and
the certificate verification protocol.

It should be understood, that although the invention is described using a certificate, that the invention is not limited to a certificate per se. The same publicly available information can be available in whole or in parts and can be separately certified.

These and other aspects of the invention will be further described by way of example and with reference to the schematic drawings, in which:

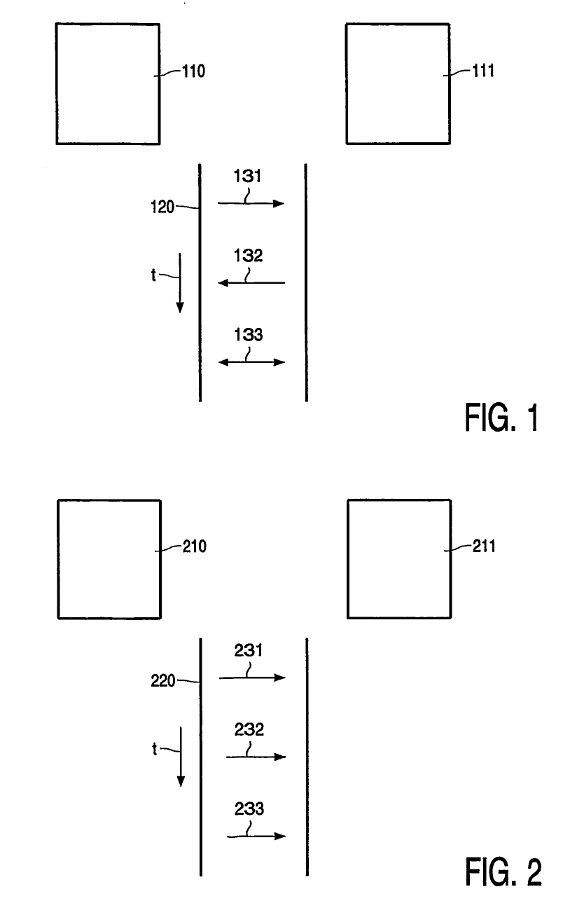

FIG. 1 illustrates a verification protocol,

FIG. 2 illustrates an issuing protocol,

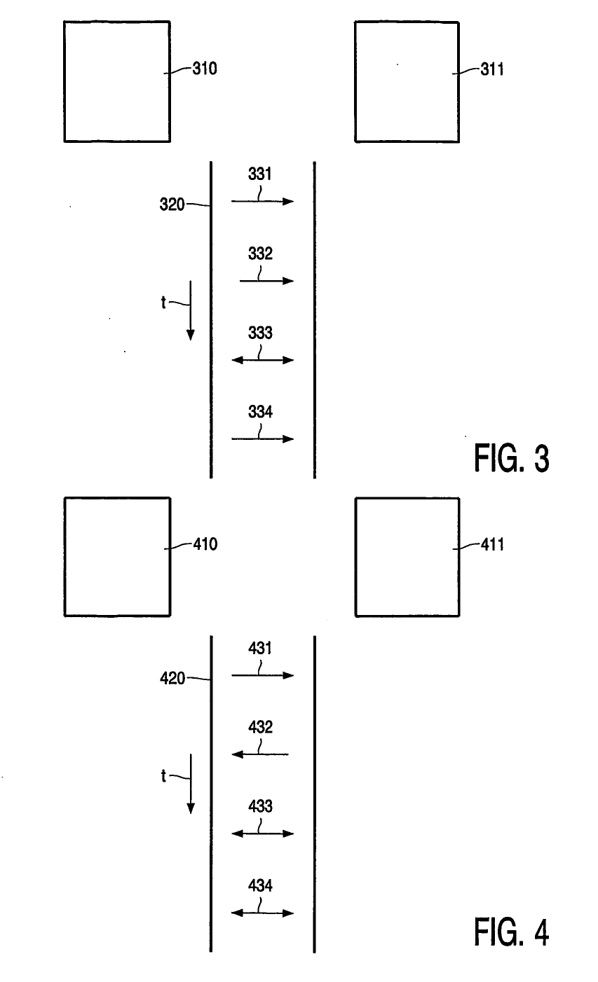

FIG. 3 illustrates a re-issuing protocol,

FIG. 4 illustrates a verification protocol for a domain co-user,

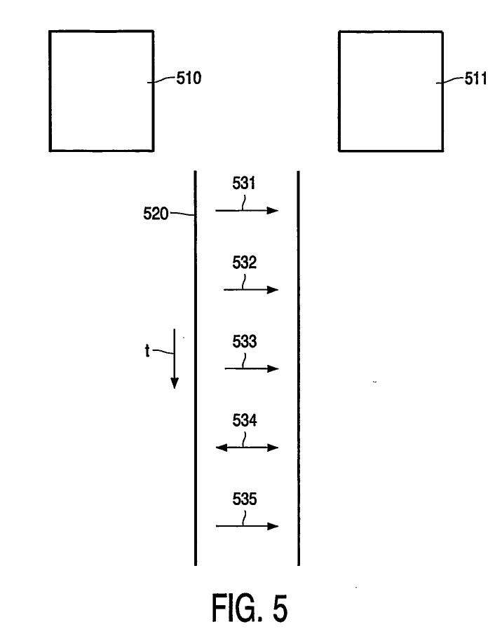

FIG. 5 illustrates an issuing protocol for a domain user,

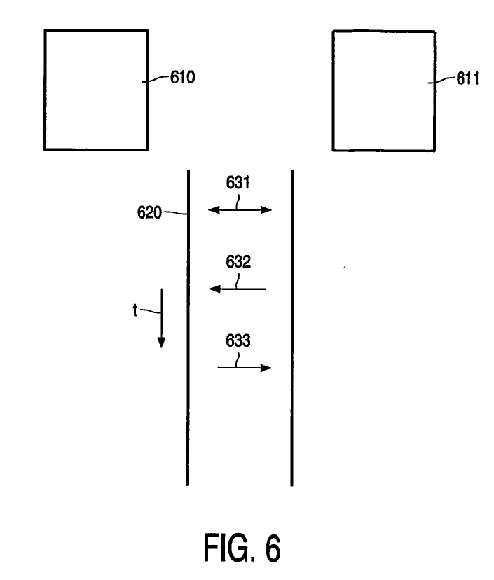

FIG. 6 illustrates a issuing protocol for a domain certificate, and

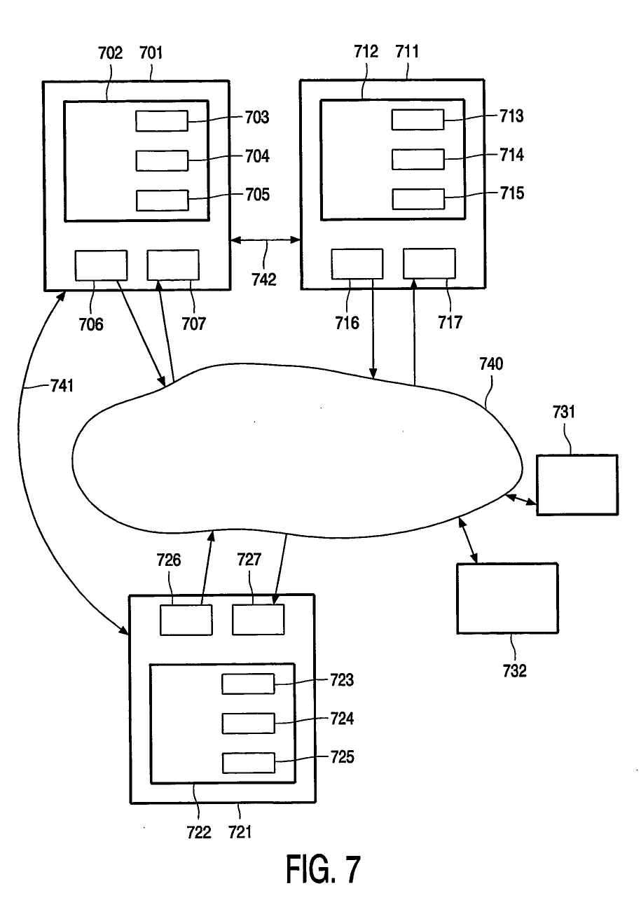

FIG. 7 illustrates a system with a verifier device, a user device, and issuing device.

In a first embodiment according to the invention, the authorization system comprises different devices, as illustrated in FIG. 7. Shown is a user device 721, which can for example be a smart card or a USB dongle. Further shown is an issuing device 711 for issuing certificates, a verifier device 701 for verifying a certificate which gives entitlement to content, and a content device (which is in this illustration combined with the verifier device, but which could also be a different device) for providing content. These devices can be interconnected through a network 740, but can also be interconnected directly as illustrated with communication channels 741 and 742. Each of the devices 701,711,721 has receivings means 706,716,726 for receiving information from a network or from other devices, for example during the protocols described in the sequel. Each of these devices further has transmitting means 707,717,727 for transmitting during these protocols, and has a processing unit 702,712,722 for processing information during protocol handling, this processing unit comprising a processor 703,713,723, a memory 704,714,724 that can also store key information, and encryption/decryption functionality illustrated in block 705,715,725.

Verifier devices and user devices are assumed to be compliant. This means that these devices comply with a given standard and adhere to certain operation rules. For a device this means, for instance, that it does not output content illegally on a digital interface. For a user device, this means that it keeps its secrets secret, and that it answers to questions and requests posed to it in the expected way.

The authorization certificate is a person's right to access a piece of content, and it is represented by means of the content right identifier, cr_id. In its simple format it can be defined as {cr_id, PK}_{signCP}, where PK is the public key of the person being granted the right to access content cr_id, and signCP is the signature of for example the issuing device on the certificate. When a user wants to access content with this certificate, he must show it to a verifier device which is able to give him directly or indirectly access to the content. User authentication must be performed, which can be accomplished by means of a protocol between the verifier device and the user device (e.g., a personal smart card), which is possessed by every user and contains a unique private/public key pair for each user. The public key of a user is therefore the identifier for that user in the system.

In this first embodiment according to the invention, a new format for the authorization certificates is used in which the user's public key is not in the clear. Moreover, in order to prevent the verifier device from learning the public key of the user device, the new format is such that certificate's verification is performed by means of a zero-knowledge protocol between the verifier device and the user device. This means that after the verification protocol, the verifier device is convinced that the user device knows some value (that only that user device could know), but nothing is revealed to the verifier device about that value.

The Fiat-Shamir identification protocol (as described in Schneier, B., Applied Cryptography: protocols, algorithms and source code in C, 2^{nd} edition, John Wiley & Sons, 1996) can be used to prove to a verifier device the knowledge of a secret value SεZₙ*, whose square value, P=S², is available as solution information to the verifier device. This problem is based on the fact that computing square roots in the multiplicative group Zₙ* is a hard problem. In applications were communication cost is an issue, for example if the user device is implemented using a smart card, the Guillou-Quisquater identification protocol (also described in the same book by Schneier) is more suited, since exchanges between the user device and the verifier device can be kept to a minimum.

The format for the authorization certificate according to the invention is for example as follows:

usage right certificate={cr_id, P, PK[S]}_{signCP},

where S is a secret value chosen in Zₙ*, the value P=S², and PK[S] is the encryption with the public key PK of the certificate's owner (referred to as user U) of the value S. This value is a different randomly chosen value in Zₙ* for each usage right certificate of user U (i.e., for each content cr_id), so the value P=S² is also unique per certificate. The user identity PK, however, which is the same for all certificates of a given user, is not in the clear. Because only the user has access to the private key corresponding to the public key used for the user identity, only the user can retrieve S from the authorization certificate. The certificate is preferably signed by a trusted party such as the issuing device (which can be the content provider).

Because the link between the authorization and the user identity is not in the clear in the certificate anymore, different authorization certificates of a single user cannot be linked. Although the verifier can be convinced that the user knows the secret S, he does not learn that value and also not the identity of the user public key PK, preserving the privacy of the user.

Note that it is not necessary to keep the S-values in storage in the user device. The step of user authentication happens implicitly when the user device retrieves the value S, for only a user who knows the private key SK, corresponding to the user public key PK, is able to decrypt PK[S] to obtain the value S.

Devices must be capable of checking the usage right certificates to give access to content only to users who are entitled to it. This can be done by means of a verification protocol as illustrated in FIG. 1. The protocol between a user device 110 that contains the private key of the user, and a verifier device 111 verifying the authorization certificate, illustrated along the timeline 120, consists of the following steps:
step 131: the user device transmits to the verifier device the content identifier cr_id and optionally locator information in order to ask for content cr_id. The optional locator can be sent to help the verifier device find the correct usage right certificate,
the verifier device retrieves the correct usage right certificate,
step 132: the verifier device sends the value PK[S] to the user device, the user device retrieves the value S using its private key (by which the authentication happens implicitly), and
step 133: the user device engages in the zero-knowledge protocol with the verifier device in order to prove that it the user device knows S.

During the zero-knowledge protocol, there are a number of rounds, and in each round, the verified device confidence increases. If the verifier device is sufficiently convinced that the user device knows the square root of P, it acts accordingly. If the verifier device acts as content device, it can give the user U access to the content. In another variation, the verifier device can communicate the results to a different device operating as content device.

FIG. 2 illustrates an issuing protocol along a timeline 220 between a user device 210 and an issuing device 211, that provides privacy for users towards the certificate issuing device as well. This mechanism allows users to anonymously acquire the certificates, yet the issuing device can ensure that the association between user and authorization, to be signed by him, will be legitimately used. In case the authorization is obtained through buying, a mechanism must be provided for the anonymous buying of certificates. Usage right certificates can be issued anonymously based on for example the pre-payment scheme described in EP03100737.0 (attorney docket PHNL030293), in which the user buys (anonymously) from the issuer a token with a secret security identifier (SSI) on it. This token can only once be used and the identifier SSI must therefore be invalidated after use. When the user device wants to obtain the rights for some content, he contacts the issuing device anonymously with a request for anonymous buying. The protocol consists of the following steps:
step 231: preferably, a symmetric session key K is established between the user device and the issuing device, in order to encrypt all information exchanged between them to ensure that the communicating parties are the same throughout the buying transaction. The key is for example established by transmission from the user device to the issuing device, where the key is protected during transmission by encryption with the user device's public key,
step 232: the user device sends a request for the content right, e.g. the value of cr_id, and the encrypted SSI value, both preferably encrypted with the session key K,
the issuing device verifies the validity of SSI and invalidates the token identifier,
the value SεZₙ* is preferably generated by the user device, in order that only the user device may know S. The user device can then calculate the values P=S² and PK[S],
step 233: the user device transmits the values P and PK[S], preferably concatenated with the cr_id to link this communication to the previous communications, and preferably encrypted with the key K for secure transmission, and
the issuing device creates and signs the usage right certificate as defined above, and the issuing device can subsequently make the usage right certificate available in the network.

It is a further advantage of this embodiment that anyone knowing the public key of a certain user can buy a usage right certificate for that certain user, for example as a present.

Re-issuing of certificates can be useful in certain cases, such as when a certificate has a limited lifetime, or when the appropriate value of cr_id has to be changed. In that case the certificate should be re-issued. FIG. 3 illustrates such a re-issuing protocol 320 between a user device 310 and an issuing device 311. An anonymous re-issuing process is normally started by the user that owns the usage right certificate, who contacts the issuing device anonymously with a request for the re-issuing:
step 331: a session key is established in step 331, for example by the user device sending the encrypted session key to the issuing device,
step 332: the user device then sends in step 332 his old usage right certificate or the reference cr_id to the old usage right certificate,
the issuing device has received or can now retrieve the P and PK[S] values for the old usage right certificate,
step 333: the user device proves to the issuing device that he is the legitimate owner of that usage right certificate by proving knowledge of the value S in the certificate (just as with the device when the user requests content),
the user device generates new values P and PK[S] for the new usage right certificate,
step 334: the issuing device receives the newly generated values P and PK[S], and
the issuing device creates and signs the re-issued usage right certificate, which can then be made available in the network.

Each time a user accesses content, he shows his usage right certificate to the verifier device. This may allow co-operating verifier devices to track users, since transactions involving the same usage right certificate (i.e., the same content) are all linkable via its values cr_id, P and PK[S]. In case the public key is revealed during a single transaction (either by accident or by an attacker), all the other transactions involving the same usage right certificate can be linked to that user. However, as long as the user's identity is not revealed, the transactions can be linked together but not linked to the user.

The linkability can be reduced by re-issuing with fresh values of P and PK[S]. For full privacy, this should be done after each single use. Such a re-issuing may be prohibitive in cases where it creates too much of a burden on the issuing device or user device. Besides, a user device might not even be able to contact the issuing device prior to a content access request. Therefore, privacy threats must be weighed against the burden of the frequent re-issuing, especially in the case of usage right certificates where linkability only happens in requests for the same content. A cheaper alternative is to perform occasional re-issuing, or re-issue only on request of the user.

The re-issuing of a given usage right certificate, is especially useful in case the user's public key is revealed, for example during a verification protocol. Re-issuing will then prevent that the user is tracked in future transactions of access to the corresponding content.

In a first variation of the first embodiment, the invention increases the security of the usage right certificate, thereby increasing the secrecy of the value S. This value S must be kept secret and should remain available only to the user. However, since the two values P=S² and PK[S] are in the clear in the certificate, an attack could be possible in which the value S is obtained from the knowledge of those two values. The following format for the usage right certificate provides additional security:

usage right certificate={cr_id, P, PK[S//RAN]}_{signCP},

where RAN is another randomly and secretly chosen number in Zₙ* for each value S (therefore for each cr_id) and the symbol // indicates concatenation of strings. With the introduction of the value RAN, the values P and PK[S//RAN] in the certificate are not uniquely related anymore, so an attack to discover S is much more difficult.

In a second variation of the first embodiment, an easy method is provided to search for a user's usage right certificate. Since the user's public key is not in the clear in the certificate anymore, finding such a certificate anywhere in the network can be greatly facilitated by an additional field, an index I, in the certificate. The new format is as follows:

usage right certificate={cr_id, P, PK[S], I}_{signCP},

where the index I=SK₁[cr_id], i.e., the encryption of cr_id with a secret symmetric key SK₁. This key is stored in the user device and is only used for that purpose. Here, the encryption scheme used is assumed to be resistant against known plain-text attacks, to ensure that an attacker cannot easily find the key SK₁ from cr_id and SK₁[cr_id]. In case such attacks are possible, two alternative improved forms for 1 are:
the index may be calculated as the square I=(SK₁[cr_id])², whose square root is hard to compute (the values cr_id and SK₁ are such that SK₁[cr_id]εZₙ*, which can be accomplished by choosing cr_idεZₙ* and SK₁εZₙ*), or
the index may be calculated as I=SK₁′[SK₁[cr_id]], where the key SK₁′ can be derived from the stored secret key SK₁ using a hash function H as SK₁′=H(SK₁).

In both cases, only the user can calculate I and an attacker has no longer available to him both the plain text cr_id and the corresponding cipher text SK₁[cr_id].

A second embodiment according to the invention makes use of a so-called authorized domain architecture. Patent application EP02079390.7 (attorney docket PHNL021063) describes a usage right certificate in the context of a person-based authorized domain architecture, which contains a reference in the certificate to a domain.

According to the present invention, the domain certificate is defined in a manner to conceal the public keys of the members. To achieve this, the new format for the domain certificate is:

domain certificate={d_id, \tilde{P}, PK[\tilde{S}], PK′[\tilde{S}], PK″[\tilde{S}], . . . }_{signDC}, (4)

where d_id is the domain identifier, \tilde{P} is calculated as \tilde{P}=(SK_{D}[\tilde{S}])², SK_{D} is a secret symmetric domain key shared by domain members only, and stored in their user devices, \tilde{S} is a value which is generated when the domain certificate is issued, and PK[\tilde{S}], PK′[\tilde{S}], PK″[\tilde{S}], . . . are the encryptions of \tilde{S} with the respective public keys of all domain members. The domain certificate is preferably signed by the domain authority DC.

With the format above, users who are a domain member can prove to a verifier device that they belong to domain d_id by means of a zero-knowledge protocol where they prove knowledge of the secret value SK_{D}[\tilde{S}]={square root over (\tilde{P}. This value can be calculated only by domain members, who can obtain \tilde{S} (by decrypting one of the terms PK[\tilde{S}], PK′[\tilde{S}], . . . ) and encrypt it with SK_{D}. The value \tilde{S} is a secret value which is generated and used by the domain certificate authority upon the issuing of the domain certificate. Its knowledge would allow any person to check if a certain public key belongs to domain d_id.

The format for the usage right certificate, that links to the domain without the domain identifier having in the clear, is for example defined as follows:

usage right certificate={cr_id, P, PK[S], D}_{signCP},

where the domain term is calculated as D=(SK_{D}[\tilde{S}×cr_id])² and the symbol × indicates multiplication of numbers in Zₙ* (the value cr_id is also chosen in Zₙ*).

The value D is used to allow any other domain user (a so-called co-user) U′ to prove to a verifier device that he also is entitled to access content cr_id. He can do so by means of a zero-knowledge protocol in which he proves knowledge of the secret value SK_{D}[\tilde{S}×cr_id]=\sqrt{D}.

In the protocol the domain certificate is needed in order for U′ to obtain the value \tilde{S}, since it is not kept in storage in the domain users' user devices. Also, the multiplication of \tilde{S} by cr_id makes the value D different for different usage right certificates. As with SK_{D}[\tilde{S}], this secret value can be calculated only by domain members.

Devices must be capable of checking the certificates in order to give access only to users who are entitled to the content. These are user U (whose public key is PK) and any other co-user U′ (whose public key is PK′) in the domain. The verification protocol for the checking by a verifier device of the usage right certificate of user U is equal to the protocol as used in the first embodiment. For co-user U′, the verification protocol is shown schematically in FIG. 4. User device 410 is now related to co-user U′. The verification protocol with the verifier device 411 consists of:
step 431: the user device requests access to content cr_id by sending cr_id and his domain identifier d_id to the verifier device. A locator, such as the index SK_{D}[cr_id], is optionally also sent to help the verifier device find the correct usage right certificate.

### Preferably, SK_{D} equals SK₁ for efficiency reasons,

the verifier device retrieves the domain certificate and the correct usage right certificate
step 432: the verifier device sends the values PK[\tilde{S}], PK′[\tilde{S}], . . . to the user device,
the user device can obtain the value \tilde{S} by using its secret key SK′ to decrypt PK′[\tilde{S}]. It then calculates the values SK_{D}[\tilde{S}] and SK_{D}[\tilde{S}×cr_id],
step 433: the user device engages in a zero-knowledge protocol with the verifier device to prove its knowledge of SK_{D}[\tilde{S}]={square root over (\tilde{P},
step 434: the user device engages in a zero-knowledge protocol with the verifier device to prove its knowledge of SK_{D}[\tilde{S}×cr_id]=\sqrt{D}, and
if the verifier device is sufficiently convinced that the user device knows both the square root of \tilde{P} (from the domain certificate) and the square root of D (from the usage right certificate), it can then give the user U′ access to the content, by transmitting the content itself, if the verifier device acts as content provider, or by for example informing the content provider about the protocol results.

All compliant user devices whose public keys were used to encrypt \tilde{S} in the domain certificate and which contain the secret domain key SK_{D} are capable of obtaining \tilde{S} and calculating SK_{D}[\tilde{S}] and SK_{D}[\tilde{S}×cr_id]. The proof of knowledge of {square root over (\tilde{P} proves that the user U′ belongs to the domain d_id, and the proof of knowledge of \sqrt{D} links the usage right certificate for content cr_id to that domain.

FIG. 5 illustrates the implementation of an issuing protocol 520 that also preserves privacy towards the certificate issuing device for users in a domain while issuing a usage right certificate for use by each domain member. Usage right certificates can be issued anonymously based on for example the pre-payment scheme described in EP03100737.0 (attorney docket PHNL030293), in which the user device 510 buys (anonymously) from the issuing device 511 a token with a secret security identifier (SSI) on it. The issuing protocol consists of:
the user device wants to obtain the rights for some content, and contacts the issuing device anonymously with a request for anonymous buying,
step 531: a symmetric session key K is preferably established between the user device and the issuing device, in order to encrypt all information exchanged between them to ensure that the communicating parties are the same throughout the buying transaction,
step 532: the user device sends in step 532 a request for the content rights, e.g. the value of cr_id, and the SSI value, both preferably encrypted with the session key K,
step 533: the user device send the value d_id to the issuing device, preferably encrypted with the session key K,
the issuing device verifies the validity of SSI and invalidates that identifier,
based on the domain identifier d_id, the issuing device then fetches the corresponding domain certificate from, e.g., a public directory,
step 534: the issuing device (optionally) sends the values PK[\tilde{S}], PK′[\tilde{S}], . . . , from the domain certificate to the user device,
the value SεZₙ* is preferably generated by the user's user device. The values P=S² and PK[S] are calculated by the user's user device after it generates the value SεZₙ*. To calculate D=(SK_{D}[\tilde{S}×cr_id])², the user device needs the value \tilde{S}, which can be obtained from the optionally received values PK[\tilde{S}], PK′[\tilde{S}], . . . , but which could also be received for example from a different source,
step 535: the user device sends the values P, PK[S] and D to the issuing device. These values are preferably concatenated with cr_id and preferably encrypted with the session key K, and
the issuing device creates and signs the usage right certificate, and makes it available in the network.

In case the user does not belong to any domain, there is no domain certificate from which the value \tilde{S} can be obtained and, in this case, the issuing device or user device can simply set D to a random value generated by itself.

It is a further advantage of this embodiment that anyone within the domain knowing the public key of a certain user can buy a usage right certificate for that user. This allows to buy content, for example as a present, for a different user.

The protocol for the issuing of domain certificates is shown schematically in FIG. 6. domain certificates are issued to a user device 610 in or representing a domain by a domain authority 611 which knows or learns the users' identities and public keys PK, PK′, . . . , which are to be grouped together in the certificate. This authority also generates the secret value \tilde{S} and a domain identifier d_id. The domain members, on the other hand, establish secretly a symmetric domain key SK_{D} (if one does not exist already), which is to be stored in their user devices. The values \tilde{S} and SK_{D} are such that SK_{D}[\tilde{S}]εZₙ*, which can be accomplished by choosing \tilde{S}εZₙ* and SK_{D}εZₙ*.

The domain certificate issuing protocol 620 is established between the authority and the user device of a domain user, with all communication done via a Secure Authenticated Channel (SAC).
step 631: the domain authority successfully authenticates the user device,
the domain authority generates a random value \tilde{S} and a domain identifier d_id,
step 632: the domain authority sends user device \tilde{S} and d_id,
the user device then calculates \tilde{P}=(SK_{D}[\tilde{S}])²,
step 633: the user device sends \tilde{P} to the domain authority, and
the values PK[\tilde{S}], PK′[\tilde{S}], . . . can be calculated by the authority itself and, together with \tilde{P} and d_id, they can be inserted in the domain certificate to be signed.

From the issuing of a domain certificate, the authority knows the secret value \tilde{S} and the association between the domain identifier d_id (and also \tilde{P}) and the public keys of the users in the domain. It does not learn, however, the value SK_{D}[\tilde{S}] which can only be calculated by domain members. This is the reason why \tilde{P} is not simply set as \tilde{P}=\tilde{S}², in order to make sure the domain certificate can not impersonate himself as a domain member.

Whether co-user U′ accesses the same or different content in two transactions, even though he is always linked to the same domain d_id, he has always anonymity within the domain. The fact that the public keys of domain members are not in the clear in the domain certificate also reinforces that anonymity. This fact allows user U to also prevent the linkability of his transactions and gain anonymity within the domain, by accessing his content via his domain membership. Anonymity within the domain is especially advantageous in case the domain is not too small.

Re-issuing of certificates as described for the first embodiment also avoids linkability of users' transactions for the second embodiment.

Note that the user U still can prove that it knows S which gives the user an advantage over a co-user U′ in the domain who cannot do so. This difference can advantageously be exploited in situations where the user should have more privileges than the other domain users. For example, the other users could have time limits or frequency limits on content access.

In a different environment, where the certificates would be used as access control to e.g. medical data, one could imagine that the user itself would have total access to his own data, while the other users have limited access to his medical data.

In yet a different environment, the user could have read and write access while other users only have read access to data.

This could be formalized by having a rule with rights specifications, stating the different permissions a user has when (1) proving its domain membership or (2) when (also) able to prove knowledge of S.

In a first variation of the second embodiment, when the user U does not need special privileges compared to the other users U′, the usage right certificate can be simplified to:

usage right certificate={cr_id, D}_{signCP}

because any user in the domain (and only users in the domain) can prove to know D. It is therefore sufficient to prove knowledge of D to prove entitlement to access cr_id, and there is no reason to include P, PK[S] in the usage right certificate anymore.

In a second variation of the second embodiment, the usage right certificate could be simplified by replacing D with d_id. The usage right certificate then looks like

usage right certificate={cr_id, d_id}_{signCP}

or

usage right certificate={cr_id, P, PK[S], d_id}_{signCP}

Only the users in the domain can prove that they are actually a domain user; therefore they are entitled to access the content cr_id, which is publicly visibly tied to d_id, even without proving any other secret than the secret in the domain certificate. Thus in the verification protocol step 434 can be skipped, reducing protocol cost.

This usage right certificate can be issued without knowing \tilde{S}. This may be an advantage as the usage right certificate can be bought by a user device for a different domain.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. A single processor or other (programmable) unit may also fulfill the functions of several means recited in the claims.

In the device claim enumerating several means, several of these means can be embodied by one and the same item of hardware. The mere fact that certain measures are recited in mutually different dependent claims does not indicate that a combination of these measures cannot be used to advantage.

1. A method of preserving privacy for a user while enabling the user controlled access to data,
the user being represented by a user device (110,721) and identified by a user identity,
the method using at least one certificate that associates data access rights with the user identity,
wherein the certificate conceals the user identity,
the certificate comprises publicly available solution information P, and
a concealed secret S′ is publicly available,
the method further comprises at least one of
a certificate verification process (120,420) between the user device and a verifier device (111,701),
a certificate issuing process (220,520,620) between the user device and an issuing device (211,711), and
a certificate re-issuing process (320) between the user device and the issuing device,
wherein the certificate verification process comprises the steps of
the user device obtaining the concealed secret S′ corresponding to the certificate,
the user device retrieving the secret S from the concealed secret S′,
the verifier device obtaining the solution information P from the certificate,
the user device proving to the verifier device that it knows the secret S without the verifier device learning the secret S or the user identity,
wherein the certificate issuing process comprises the steps of:
generating a secret S and a solution information P,
concealing the secret S into a concealed secret S′,
the issuing device issuing a certificate comprising at least the solution information P,
wherein the certificate re-issuing process comprises the steps of
the user device obtaining the concealed secret S′ corresponding to the certificate,
the user device retrieving the secret S from the concealed secret S′,
the issuing device obtaining the solution information P from the certificate,
the user device proving to the issuing device that it knows the secret S without the issuing verifier device learning the secret S or the user identity,
generating a new secret S2 and new solution information P2,
concealing the secret S2 into a concealed secret S2′,
the issuing device issuing a new certificate comprising at least the new solution information P2.

2. The method according to claim 1, wherein the certificate comprises publicly available concealed secret S′.

3. The method according to claim 2, wherein the secret S is encrypted with the user's public key to generate the concealed secret S′.

4. The method according to claim 1, wherein the solution information P and the secret S are members of Zn*, and the solution information P is the square of S.

5. The method according to claim 1, wherein the concealed secret S′ comprises random information RAN.

6. The method according to claim 1, wherein the verifier device verifies that the user device has knowledge of the secret S using a zero-knowledge protocol.

7. The method according to claim 1, wherein the communication during the issuing process is protected using symmetric key encryption.

8. The method according to claim 1, wherein in the issuing process the secret S and the solution information P is generated by the user device.

9. The method of claim 1, wherein the certificate is an authorization certificate.

10. The method of claim 1, wherein the certificate is a domain certificate.

11. The method according to claim 10, wherein the concealed secret S′ in the domain certificate comprises the secret S, encrypted with the secret domain key.

12. The method according to claim 9, wherein the concealed secret S′ comprises the secret S, multiplied with cr_id.

13. The method according to claim 1, wherein the certificate comprises two secrets, of which the knowledge prove by a user device gives different access levels.

14. User device (110,721) being arranged for issuing a certificate according to claim 1, comprising:
receiving means (727) for receiving process information,
computing means (722), comprising processing (723), encryption/decryption (725) and storing means (724), for engaging in at least one of the certificate verification process, the certificate issuing process, and certificate re-issuing process, and
transmitting means (726) for transmitting process information.

15. Verifier device (111,701) being arranged for verifying a certificate according to claim 1, comprising:
receiving means (707) for receiving process information,
computing means (702), comprising processing (703), encryption/decryption (705) and storing means (704), for engaging in the certificate verification process, and
transmitting means (706) for transmitting process information.

16. Issuing device (211,711) being arranged for issuing a certificate according to claim 1, comprising:
receiving means (717) for receiving process information,
computing means (712), comprising processing (713), encryption/decryption (715) and storing means (714), for engaging in at least one of the certificate issuing process and certificate re-issuing process, and
transmitting means (716) for transmitting process information.

17. Signal carrying at least part of a certificate as used in the method according to claim 1.

18. A computer program product (732) carrying computer executable instructions comprising a computer readable medium, having thereon computer program code means, to make a computer execute, when said computer program code means is loaded in the computer, implementing at least one protocol side of at least one of:
the certificate issuing protocol,
the certificate re-issuing protocol, and
the certificate verification protocol.
